(19) United States
(12) Patent Application Publication
(10) Pub. No.: US 2018/0285791 A1
(43) Pub. Date: Oct. 4, 2018

(54) SPACE OPTIMIZATION SOLVER USING TEAM COLLABORATION PATTERNS TO GUIDE TEAM-TO-FLOOR ALLOCATION PLANNING

(71) Applicant: Microsoft Technology Licensing, LLC, Redmond, WA (US)

(72) Inventors: Aleksey Ashikhmin, Redmond, WA (US); Lin Xiao, Bellevue, WA (US); Si Meng, Seattle, WA (US); Chantrelle Nielsen, Seattle, WA (US)

(21) Appl. No.: 15/472,580

(22) Filed: Mar. 29, 2017

(51) Int. Cl. G06Q 10/06; G06F 3/0484; G06Q 10/10

(52) U.S. Cl. CPC G06Q 10/0631; G06Q 10/109; G06F 3/04847

(57) ABSTRACT

Various embodiments of the present technology provide for a space optimization tool. More specifically, some embodiments provide for a space optimization tool that uses team collaboration patterns to guide team-to-location allocation planning. Some embodiments of the space optimization tool use social collaboration data that tracks people's communication patterns, such as how frequently teams talk to each other. The social collaboration data can be used to by the space optimization tool to guide how individuals and teams should sit on different locations (e.g., within floors, buildings, etc.). The space optimization tool can create a smart floor layout that achieves desired business outcomes, such as minimizing employee's commute time to other teams, stimulating collaborations between teams, and the like. In accordance with various embodiments, the space optimization tool can create a smart layout by using an optimization model to automatically optimize a target function at global level.

### BACKGROUND

Successful companies of all sizes need employees to work jointly together and collaborate on various projects, designs, and other endeavors. This is true of intellectually based endeavors as well as physically based endeavors. As part of the collaboration process, employees often meet in conference rooms or other collaborative space in order to share ideas, share project goals, share project status and otherwise facilitate portions of the collaboration. For very small companies, all of the employees can easily fit within a small space. As companies grow, however, the employees become more spread out within the same building, multiple buildings within an office complex, and eventually within multiple buildings around the world.

Larger companies often create various divisions or teams of employees to focus on developing knowledge in specific areas. These employees are often collocated within the office space, but determining which divisions or teams should sit next to each other can be a difficult task as the company occupies multiple floor and/or multiple buildings. In many instances the decision on where specific employees, or groups of employees, are physically located may be based on criteria that may not result in more effective collaboration. For example, the decisions may be relatively random, based on seniority, based on a level of importance within the company, or the like. As a result, locating employees based on these types of criteria may not result in the optimal entity efficiency and engagement.

Overall, the examples herein of some prior or related systems and their associated limitations are intended to be illustrative and not exclusive. Upon reading the following, other limitations of existing or prior systems will become apparent to those of skill in the art.

### Overview

Various embodiments of the present technology generally relate to space optimization tools. More specifically, some embodiments provide for space optimization tools that use team collaboration patterns to guide team-to-location allocation planning. Some embodiment of the space optimization tool uses social collaboration data that tracks people's communication patterns, such as how frequently teams talk to each other. The social collaboration data can be used to by the space optimization tool to guide how individuals and teams should sit on different locations (e.g., within floors, buildings, team areas, desks, etc.). The space optimization tool can create a smart location layout that achieves desired business outcomes, such as minimizing employee's commute time to other teams, stimulating collaborations between teams, and the like. In accordance with various embodiments, the space optimization tool typically does not rely on the existence of prior layouts, and instead creates a smart layout by using an optimization model to automatically optimize a target function at global level.

Embodiments of the present invention also include computer-readable storage media containing sets of instructions to cause one or more processors to perform the methods, variations of the methods, and other operations described herein.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Embodiments of the present technology will be described and explained through the use of the accompanying drawings in which:

FIG. 1 illustrates an example of a communications environment in which some embodiments of the present technology may be utilized;

FIG. 2 illustrates a set of components associated with a space optimization tool according to one or more embodiments of the present technology;

FIG. 3 illustrates an example of a set of operations for generating a smart location plan according to one or more embodiments of the present technology;

FIG. 4 illustrates an example of a set of operations for operating a space optimization tool according to one or more embodiments of the present technology;

FIG. 5 illustrates an example of inputs and outputs for a space optimization tool in accordance with some embodiments of the present technology;

FIG. 6 is flowchart illustrating an example of a set of operations for operating a graphical user interface of a space optimization tool in accordance with one or more embodiments of the present technology;

FIG. 7 is an example of a graphical user interface that may be used in accordance with some embodiments of the present technology;

FIG. 8 is a sequence diagram illustrating an example of the data flow between various components of a system capable of generating smart location plans according to various embodiments of the present technology; and

FIG. 9 illustrates an example of a computing system, which is representative of any system or collection of systems in which the various applications, services, scenarios, and processes disclosed herein may be implemented.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology generally relate to space optimization tools. More specifically, some embodiments provide for space optimization tools that use team collaboration patterns to guide team-to-location allocation planning. Some embodiment of the space optimization tool uses social collaboration data that tracks people's communication patterns, such as how frequently teams talk to each other. The social collaboration data can be used to by the space optimization tool to guide how individuals and teams should sit on different locations (e.g., within floors, buildings, team areas, desks, etc.). The space optimization tool can create a smart location layout that achieves desired business outcomes, such as minimizing employee's commute time to other teams, stimulating collaborations between teams, and the like. In accordance with various embodiments, the space optimization tool typically does not rely on the existence of prior layouts, and instead creates a smart layout by using an optimization model to automatically optimize a target function at global level.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. While, for convenience, embodiments of the present technology are described with reference to creating smart location layouts that place individuals and teams within the company's facilities in a manner that creates efficient team collaboration, embodiments of the present technology are equally applicable to various other applications such as locating equipment. Similarly, the optimization model and method described may apply to other problems, such as space allocation across different buildings (in addition to across floors), and a mixture of both floor, buildings and campuses.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

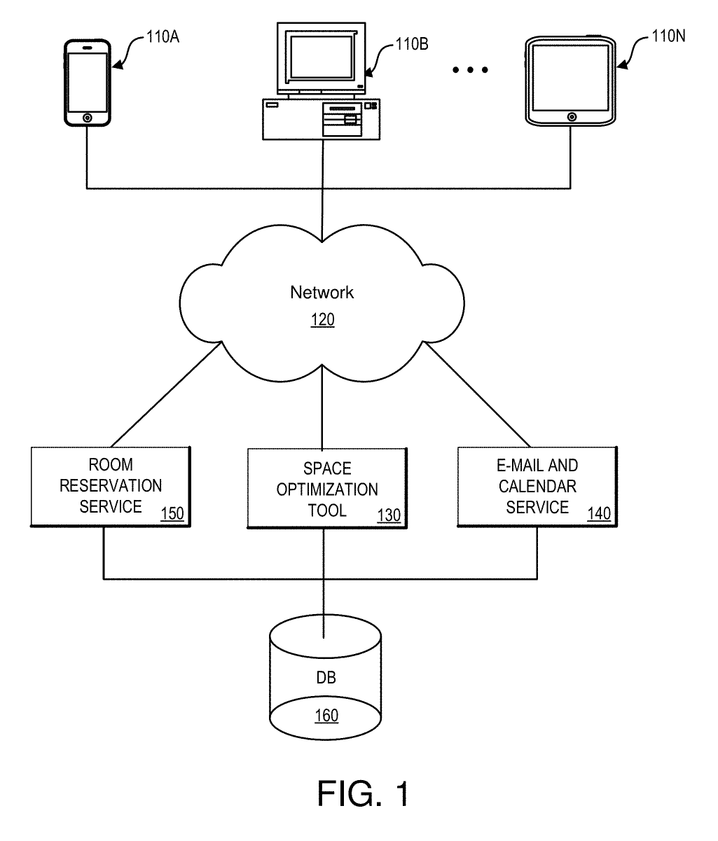

FIG. 1 illustrates an example of a communications environment 100 in which some embodiments of the present technology may be utilized. As illustrated in FIG. 1, communications environment 100 may include one or more computing devices 110A-110N (such as a mobile phone, computer, tablet computer, mobile media device, wearable computing device, etc.), communications network 120, remote servers running space optimization tool 130, e-mail and calendar service 140, and room reservation service 150, and database 160.

Those skilled in the art will appreciate that various components (not shown) may be included in computing device 110A-110N to enable network communication with communication network 120. In some cases, communication network 120 may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

As illustrated in FIG. 1, space optimization tool 130 can be a software application running on one or more remote servers which can be accessed using computing devices 110A-110N via network 120. Space optimization tool 130 can collect team collaboration patterns from e-mail and calendar service 140 and room reservation service 150. The e-mails, calendar entries, and room reservations entries can be analyzed to identify interactions between members of an organization. For example, information such as where the meeting was located, who attended the meeting, how long the meeting lasted, was a virtual meeting available, who sent the invite, and the like can be collected. In addition, to formal meetings in conference rooms, some embodiments also analyze personal messaging chat records, phone records, and other data that may indicate interactions between members of the organization.

Using human resource (HR) data (e.g., retrieved from database 160 or some other source) the space optimization tool can identify additional meta data regarding the meeting participants. This information can include, but is not limited to, an individual's level within the organization, an individual's job function, team assignments within the organization, current physical location, position on an organization chart, and the like. This data can be compiled and turn into time use data to get a number of hours between any one person and any other person, one team and any other team, etc. This collaboration data will be the basis for an interaction matrix representing a number of interactions or amount of interactions between individuals and/or teams. In some embodiments, different types of data may be discounted or weighted. For example, the time on the phone may be discounted by 20% compared to in person meetings while e-mails may be discounted even more.

In addition to the collaboration data, travel data representing the time to travel between teams or individuals may also be used as an input to the tool. In addition to the collaboration data and travel data, space optimization tool 130 can receive additional inputs such as floor layouts, floor capacity, team size data, constraints on specific team locations (e.g., some teams cannot be on certain floor, some teams must be on certain floor, no more than a certain amount of a team on certain floor, etc.). Some of these inputs may be received from a user via computing device 110A-110N, while other inputs may be pulled from additional data sources.

Using the available inputs, space optimization tool 130 can then generate a recommendation on where individuals and teams should sit on different locations (e.g., within floors, buildings, etc.). This seating chart, referred to as a smart location plan or layout, can be designed by space optimization tool to achieve desired business outcomes, such as minimizing employee's commute time to other teams, stimulating collaborations between teams, and the like. In accordance with various embodiments, space optimization tool 130 can ensure that the all of the team members are placed somewhere on the available floors/buildings/locations, that any floor/building/location doesn't exceed capacity, etc. In various embodiments, the space optimization tool does not rely on the existence of prior layouts, and instead creates a smart layout by using an optimization model to automatically optimize a target function at global level.

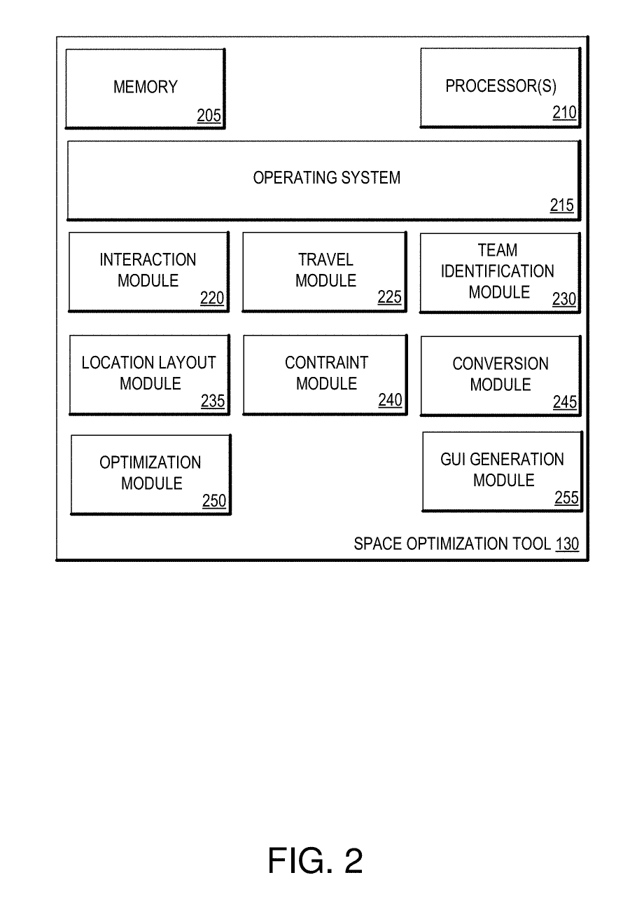

FIG. 2 illustrates a set of components associated with a space optimization tool 130 according to one or more embodiments of the present technology. According to the embodiments shown in FIG. 2, space optimization tool 130 can include memory 205, one or more processors 210, operating system 215, interaction module 220, travel module 225, team identification module 230, location layout module 235, constraint module 240, conversion module 245, optimization module 250, and graphical user interface (GUI) generation module 255. Each of these modules can be embodied as special-purpose hardware (e.g., one or more ASICS, PLDs, FPGAs, or the like), or as programmable circuitry (e.g., one or more microprocessors, microcontrollers, or the like) appropriately programmed with software and/or firmware, or as a combination of special purpose hardware and programmable circuitry. Other embodiments of the present technology may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, interaction module 220 and team identification module 230 can be combined into a single module for identifying team members and their interactions.

Memory 205 can be any device, mechanism, or populated data structure used for storing information. In accordance with some embodiments of the present technology, memory 205 can encompass any type of, but is not limited to, volatile memory, nonvolatile memory and dynamic memory. For example, memory 205 can be random access memory, memory storage devices, optical memory devices, media magnetic media, floppy disks, magnetic tapes, hard drives, SDRAM, RDRAM, DDR RAM, erasable programmable read-only memories (EPROMs), electrically erasable programmable read-only memories (EEPROMs), compact disks, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 205.

Memory 205 may be used to store instructions for running one or more applications or modules on processor(s) 210. For example, memory 205 could be used in one or more embodiments to house all or some of the instructions needed to execute the functionality of operating system 215, interaction module 220, travel module 225, team identification module 230, location layout module 235, constraint module 240, conversion module 245, optimization module 250, and/or GUI generation module 255. Operating system 215 provides a software package that is capable of managing the hardware resources of space optimization tool 130. Operating system 215 can also provide common services for software applications running on processor(s) 210.

Interaction module 220 can identify interactions between members of multiple teams within the organization. For example, in some embodiments, the interaction data can be entered manually from a user interface, loaded from data files or automatically identified by analyzing available data. In some embodiments, patterns from e-mail, calendars, room reservations, messaging data, phone data, and other interaction data can be analyzed to identify interactions and collaborations. Based on these interactions between the members of the multiple teams within the organization, interaction module 220 can generate an interaction matrix that represents the number of interactions between each of the multiple teams. The interaction matrix, along with other inputs can be used by optimization module 250.

Travel module 225 can create a travel matrix based on travel times between the multiple teams during the interactions of the members of the multiple teams. The travel times may be provided by a user, estimated using floor plans, estimated based on traffic patterns between buildings, from team member provided data (e.g., via survey), or the like. Team identification module 230 can identify (e.g., based on e-mail, HR and/or calendar data) team members and meetings between the different teams. In some embodiments, team identification module 230 may record the location of the meetings between the members of the multiple teams. This data may be provided as an input into travel module 225. In some embodiments, team identification module 230 can use human resource (HR) data to identify additional meta data regarding the meeting participants (an individual's level within the organization, an individual's job function, team assignments within the organization, current physical location, position on an organization chart, and the like).

In some embodiments, location layout module 235 can analyze floor plans or other information about a location and determine the capacity of each floor or location. The capacity of each floor or location may be provided by the user (e.g., via a user interface or data file). In some embodiments, location layout module 235 may provide an initial capacity that can be altered the user. For example, the user may know additional development plans (e.g., addition of conference rooms, subleasing, etc.) Any inputs provided by the user can be translated into constraints using constraint module 240. For example, constraint module 240 can receive the capacity of the one or more locations and a set placement of a certain number of members in specific locations (e.g., floors, team areas, etc.). Conversion module 245 can translate convert any data, messages or queries into the proper format.

Optimization module 250 can setup and generate a smart location plan by solving an optimization problem. The smart location plan can identify how the multiple teams should be physically located within the organization. In some embodiments, optimization module 250 can find a descent direction and use a line search to minimize an objective function. Some embodiments can use other optimization techniques (e.g., numerical search algorithms). Depending on the problem to be solved, optimization module 250 may not be able to solve the optimization problem with a guarantee of global minimum. A such, in some embodiments, an interactive approach may be used that includes a search grid that starts from a variety of initiation conditions. As such, the problem may be solved 10, 100, 1000, 10000, or more times and the best solution taken from those.

More formally, suppose the user wants to allocate seatings for K teams in N locations (e.g., floors), with the following parameters:
The interaction matrix I ∈R^{K×K}, where each element Iₖₗ represents the collaboration intensity between team k and l.
The travel matrix T∈R^{N×N}, where each element Tᵢⱼ represents the amount of time needed to travel from location i to location j.
The team size vector s ∈R^{K}, where each element sₖ represents the number of people in team i.
The location capacity vector c∈R^{N}, where each element cᵢ represents the maximum number of people that can be assigned to location i.

In accordance with some embodiments, optimization module 250 can first check that all of the elements of I, T, s, and c are nonnegative. If a negative element is detected, the optimization tool can generate a warning and possibly exit. The decision variables can be elements of the matrix X∈R^{K×N}, where element Xₖᵢ denotes the fraction of people from team k allocated on location i. Let Xᵢ ∈R^{K} denote the i^{th} column of the matrix X, that is, Xᵢ=[X₁ᵢ, . . . , X_{Ki}]. As a result, the mathematical formulation of the Team Seating problem can be written as:

minimize Σᵢ₌₁^{N}Σⱼ₌₁^{N}Tᵢⱼ(Xᵢ^{T}IXⱼ)

subject to Σᵢ₌₁^{N}Σₖᵢ=1,k=1, . . . ,K,

Σₖ₌₁^{K}Xₖᵢsₖ≤cᵢ,i=1, . . . ,N,

Xₖᵢ≥0,k=1, . . . ,K,i=1, . . . ,N. (1)

Some embodiments rewrite the problem with more compact notation:

minimize Tr(TX^{T}IX)

subject to X1=1,X^{T}s≤c,X≥0, (2)

where Tr(·) denotes the trace of a square matrix, 1 denotes the vector of all ones with appropriate dimension, and the equalities and inequalities all hold element-wise.

An objective function can then be selected. In some embodiments, the objective function can be written as f(X)=Tr(T X^{T} I X). Optimization module 250 can compute its gradient as

∇f(X)=I X T+I^{T}×T^{T},

which is a matrix with the same dimension as X. If T is symmetric, then

∇f(X)=(I+I^{T})X T

Further assuming I=I^{T} the gradient can be computed as lead to ∇f(X)=2 I X T. Some embodiments, use the Frank-Wolfe algorithm to find the optimal (or nearly optimal) solution that can represent the smart location plan. The Frank-Wolfe algorithm can be described as follows:

The Frank-Wolfe Algorithm:

```
Choose an initial point X⁽⁰⁾ ∈ R^{K×N} (default Xₖᵢ⁽⁰⁾ = 1/N for all k and i).
Repeat for k = 0, 1, 2, . . .
  1. Compute G = ∇f(X^{(k)}) = (I + I^{T})X^{(k)}T.
  2. Solve the following linear program for Y ∈ R^{K×N},
      minimize Tr(G^{T}Y) = Σₖ₌₁^{K} Σᵢ₌₁^{N} GₖᵢYₖᵢ
      subject to Y1 = 1, Y^{T} s ≤ c, Y ≥ 0.
  $3. Choose step size γ ( default γ = \frac{1}{( k + 2 )} ) .$
  4. Update X^{(k+1)} = X^{(k)} + γ(Y − X^{(k)}).
Until ||X^{(k+1)} − X^{(k)}||_{F} ≤ ϵ.
```

In the stopping criteria, ∥ ∥_{F} denotes the matrix Frobenius norm, that is,

$${‖ {X}^{( k + 1 )} - {X}^{( k )} ‖}_{F} = \sqrt{{\sum }_{k = 1}^{K} {\sum }_{i = 1}^{N} {( {X}_{ki}^{( k + 1 )} - {X}_{ki}^{( k )} )}^{2}} ,$$

and ∈ is a small positive number (e.g., ∈=0.001). Any other norm can be used to replace the Frobenius norm. Some embodiments can use a relative criteria such as

∥X^{(k+1)}−X^{(k)}∥_{F}/∥X^{(k)}∥_{F}≤∈.

Step 2 in the algorithm can solve a linear program with the variable Y. As such, some embodiments of optimization module 250 can use any LP solver, including, but not limited to, the one in Microsoft Solver Foundation, R, Python, or MATLAB.

In step 3, the simple step size rule γ=1/(k+2) can cause very slow convergence. To speed up the convergence, some embodiments choose the step size γ using exact line search. To simplify notation, here we use X to denote X(k). In some embodiments, optimization module 250 can find γ to minimize the merit function

$$\begin{matrix}φ ( γ ) = f ( X + γ ( Y - X ) ) = f ( ( 1 - γ ) X + γ Y ) \\ = Tr ( {T ( ( 1 - γ ) X + γ ( Y ) )}^{T} I ( ( 1 - γ ) X + γ Y ) \\ = {( 1 - γ )}^{2} {t}_{xx} + γ ( 1 - γ ) {t}_{xy} + {γ}^{2} {t}_{yy}\end{matrix} where$$

$${t}_{xx} = Tr ( {TX}^{T} IX )$$

$${t}_{xy} = Tr ( {TX}^{T} IY ) + Tr ( {TY}^{T} IX )$$

$${t}_{yy} = Tr ( {TY}^{T} IY )$$

Therefore, the merit function can be expressed as

ϕ(γ)=aγ2+bγ+c,

where
a=tₓₓ−t_{xy}+t_{yy}, b=tx_{y}−2tₓₓ, c=tₓₓ.

Then the simple quadratic function ϕ(γ) can be minimized over the interval γ∈ [0, 1], which yields the following solution:

$$If a > 0 , then γ = \{ \begin{matrix}1 , & \frac{- b}{2 a} \geq 1 , \\ \frac{- b}{2 a} , & 0 < \frac{- b}{2 a} < 1 , \\ 0 , & \frac{- b}{2 a} < 0.\end{matrix} \\ If a < 0 , then γ = \{ \begin{matrix}0 , & \frac{- b}{2 a} \geq 1 , \\ 0 , & 0 < \frac{- b}{2 a} < 1 and a + b > 0 , \\ 1 , & 0 < \frac{- b}{2 a} < 1 and a + b \leq 0 , \\ 1 , & \frac{- b}{2 a} < 0.\end{matrix} \\ If a = 0 , then γ = \{ \begin{matrix}0 , & b \geq 0 , \\ 1 , & b < 0.\end{matrix}$$

The capacity constraints described above for total fractions for allocating each team is one (X·1=1 or Y·1=1), and the total allocated spaces on each floor generally should be less than the floor capacity (X^{T}s≤c or Y^{T}s≤c). These constraints can be respected in most embodiments. Some embodiments, allow for any additional linear constraint on the variables. According to various embodiments, here are some examples:
X_{{2,5}}≥(≤)0.3 means: at least (no more than) 30% of team #2 should be allocated on floor 5.
X_{{3,4}}=0 means that no member of team #3 should be allocated on floor 4.
X_{{1,3}}=1 means that all members of team #1 should be allocated on floor 3.
X_{{3,2}}+X_{{3,5}}=1 means that team #3 can only be allocated on either floor 2 or floor 5.

There can be many other similar combinations, which serve the purpose of accommodating additional space allocation constraints that are not determined from the interaction matrix.

GUI generation module 255 can generate one or more GUI screens that allow for interaction with a user. In at least one embodiment, GUI generation module 255 can generate a graphical user interface allowing a user to set preferences, review reports, set constraints, and/or otherwise receive or convey information about smart location plans to the user. For example, in some embodiments, GUI generation module 255 can generate a graphical user interface that can be displayed on a client device. The graphical user interface can include a first interface that allows a user of the client device to enter capacity of one or more locations (e.g., floors, buildings, team areas, etc.) on which the members within the organization can be located. The graphical user interface can also include a second portion or screen that allows a user of the client device to set placement of a certain number of members in specific locations (e.g., floors, buildings, team areas, etc.). A third portion or screen can provide a graphical display representing the smart location plan as a table of team members per location.

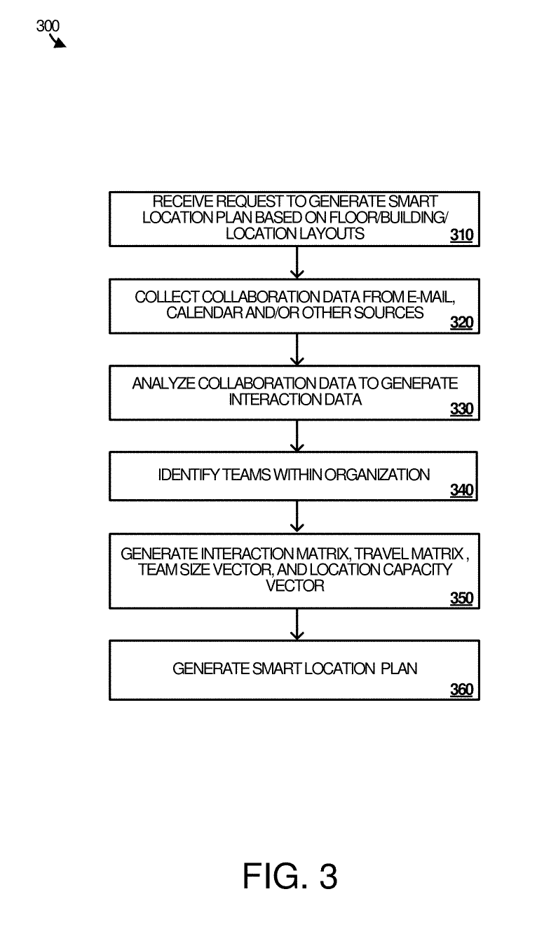

FIG. 3 illustrates an example of a set of operations 300 for generating a smart location plan according to one or more embodiments of the present technology. The operations illustrated in FIG. 3 can be performed by a computing device, server, space optimization tool, or one or more components (e.g., processor(s) 210), engines, and/or modules associated with space optimization tool 130. As illustrated in FIG. 3, monitoring operation 310 relieves a request to generate a smart location plan based on a floor/building/location layout. The floor/building/location layout may include multiple floors or team areas that are potentially located across multiple buildings.

Collection operation 320 collects collaboration data from various sources (e.g., e-mail, calendar entries, phone records, instant messaging data, etc.). This can be done by automatically interfacing with other systems (e.g., e-mail system, room reservation system, etc.) and accessing the service data directly. In other cases, this data may be provided by as a data file for analysis. Once the collaboration data has been collected, generation operation 330 analyzes the data and generates a set of interaction data.

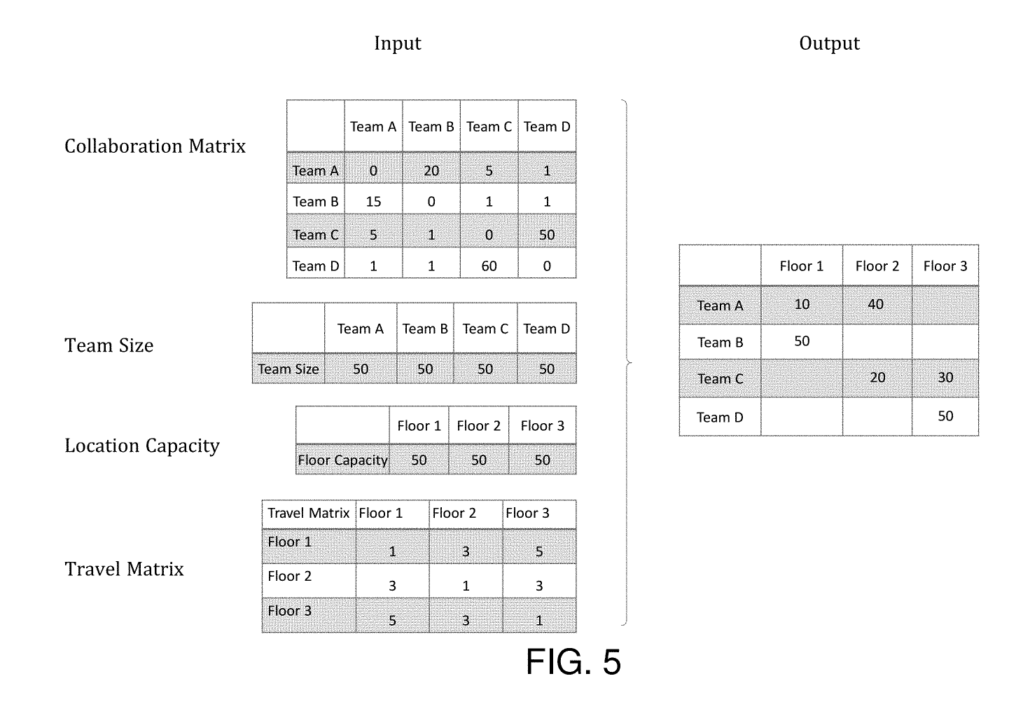

Team identification operation 340 can identify the teams within the organization. This can be done, for example, by analyzing HR data, team charts, surveys, or the like. Once all of the data has been collected, generation operation 350 can generate an interaction matrix, travel matrix team size vector, and location capacity vector (see, e.g., FIG. 5 for an example illustration of these vectors and matrices) which can be used to generate a smart location plan in planning operation 360.

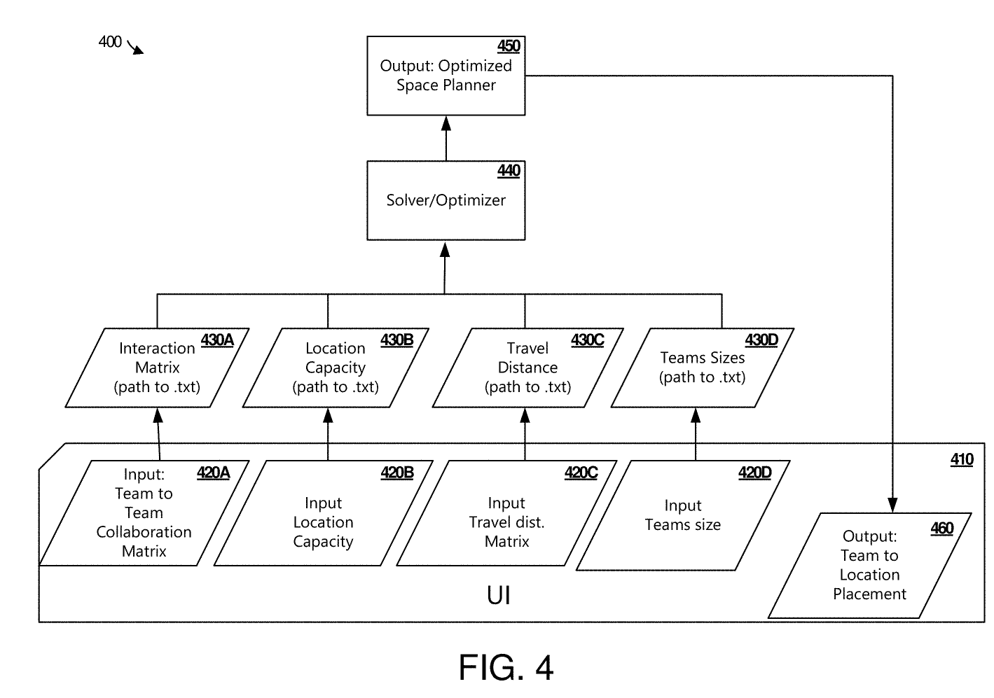

FIG. 4 illustrates an example of a set of operations 400 for operating a space optimization tool according to one or more embodiments of the present technology. The operations illustrated in FIG. 4 can be performed by a computing device or one or more components (e.g., processor(s) 210), engines, and/or modules associated with the space optimization tool. As illustrated in FIG. 4, user interface 410 can be used to receive inputs 420A-420D from a user. These inputs can include team-to-team collaboration data, location capacity, travel distance matrix, and team sizes.

These inputs can be translated in to various matrices and vectors, such as interaction or collaboration matrix 430A, location capacity vector 430B, travel matrix 430C and team size vector 430D, and fed to solver/optimizer 440. Solver/optimizer 440 can run one or more optimization algorithms to generate an optimized space planner 450 which can then be translated into team to floor/building/location placement (i.e., smart location plan) via user interface 410. FIG. 5 illustrates an example of inputs and outputs for a space optimization tool in accordance with some embodiments of the present technology.

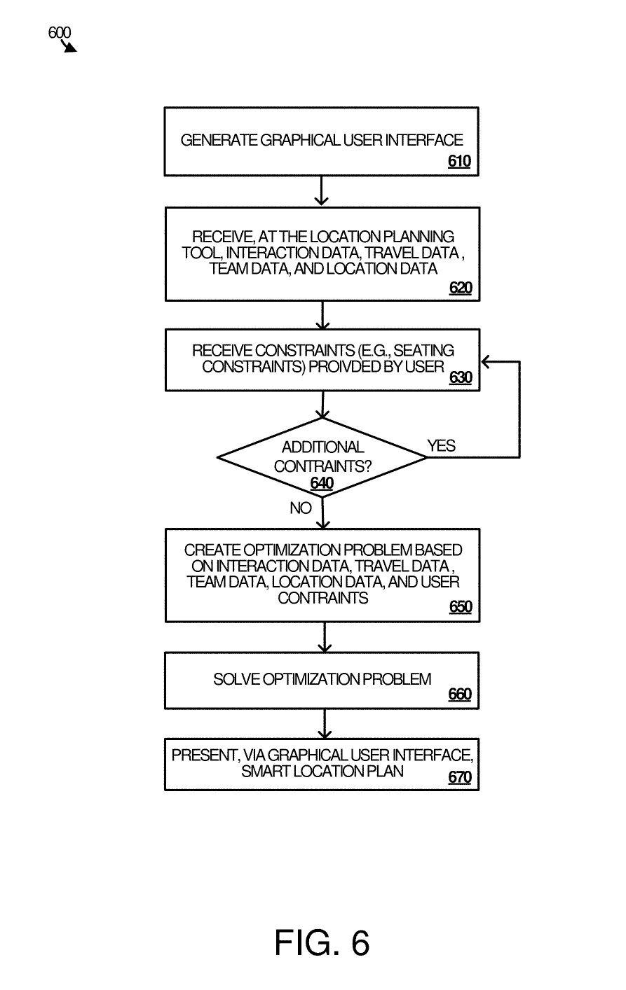

FIG. 6 is flowchart illustrating an example of a set of operations 600 for operating a graphical user interface of a space optimization tool in accordance with one or more embodiments of the present technology. The operations illustrated in FIG. 6 can be performed by a computing device, server or one or more components (e.g., processor(s) 210), engines, and/or modules associated with the space optimization tool. As illustrated in FIG. 6, generation operation 610 generates a graphical user interface that can receive, during receiving operation 620, interaction data, travel data team data, and location data. In accordance with various embodiments, the user can provide the data (e.g., by typing or indicating file locations where the data can be obtained) in a variety of ways. In addition, the various constraints may also be provided by the user during constraint operation 630. For example, certain teams may need to be placed in a certain location due to physical equipment locations, preferences, or other reasons.

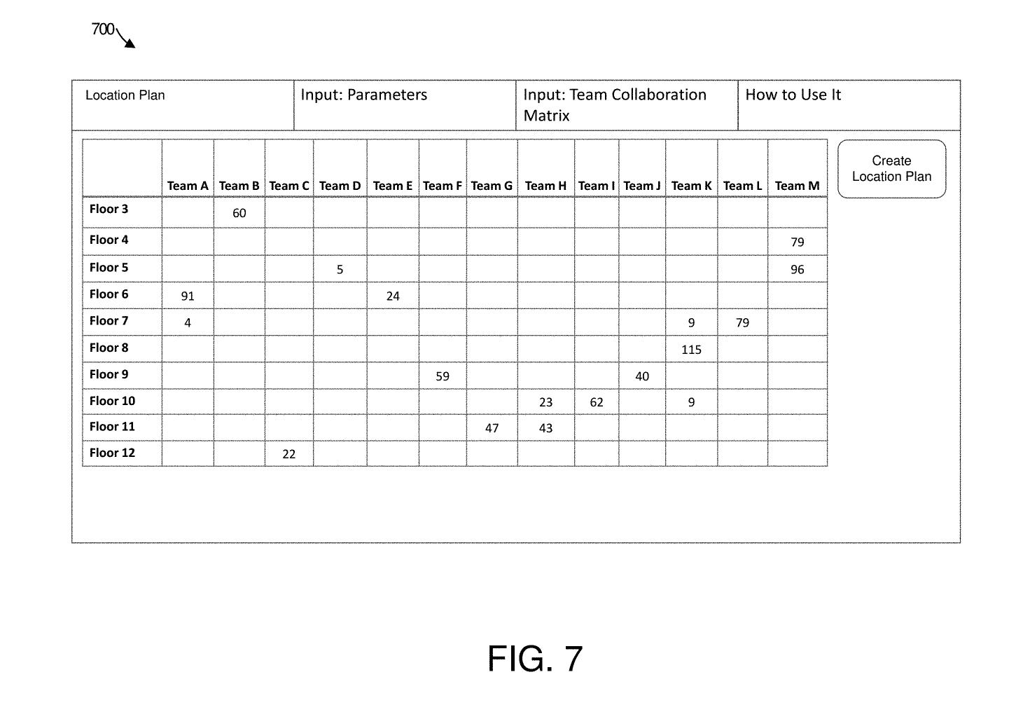

During determination operation 640, a determination is made as to whether the user would like to provide additional constraints. If determination operation 640 determines that additional constraints are forthcoming, determination operation 640 branches to constraint operation 630 where additional constraints are provided. In some cases, this may include a modification previously provided constraints (e.g., if the tool provides an indication that the constraints are not feasible). If determination operation 640 determines that additional constraints are not forthcoming, determination operation 640 branches to creation operation 650 where an optimization problem is created based on the interaction data, travel data, team data, floor data, location data, and user constraints. The optimization problem can be solved (or approximated) using solving operation 660 and the results (e.g., the smart location plan) is presented via the user interface during presentation operation 670. FIG. 7 is an example of a graphical user interface 700 that may be used in accordance with some embodiments of the present technology to present the smart location plan during presentation operation 670.

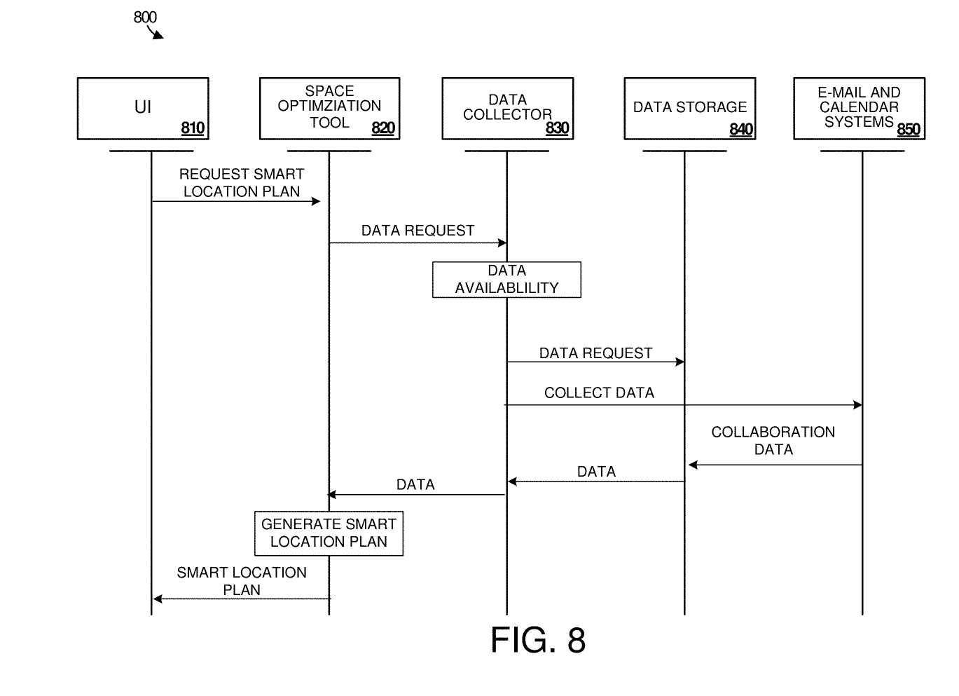

FIG. 8 is a sequence diagram illustrating an example of the data flow between various components of a system capable of generating smart location plans according to various embodiments of the present technology. A smart location plan can be requested, via user interface 810, from space optimization tool 820. Space optimization tool can request data from data collector 830 which can determine the data location and the most efficient manner to collect the data. For example, data collector 830 can send a data collection request to data storage 840, collect data from e-mail and calendar system 850 and the like. The requested data can be returned to data collector 830 which can transmit the data to space optimization tool 820. Space optimization tool 820 can generates a smart location plan and return that to the user via user interface 810.

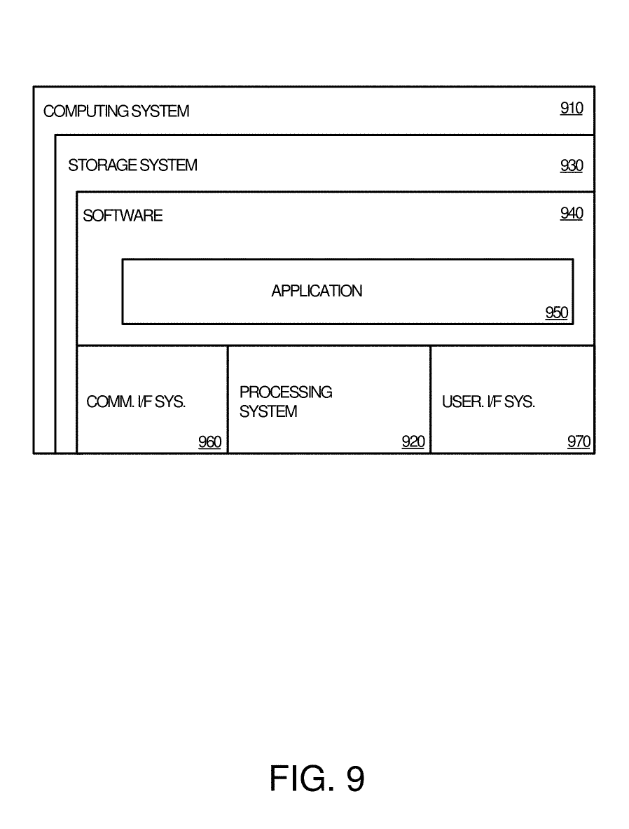

FIG. 9 illustrates computing system 910, which is representative of any system or collection of systems in which the various applications, services, scenarios, and processes disclosed herein may be implemented. For example, computing system 910 may include server computers, blade servers, rack servers, and any other type of computing system (or collection thereof) suitable for carrying out the enhanced collaboration operations described herein. Such systems may employ one or more virtual machines, containers, or any other type of virtual computing resource in the context of supporting enhanced group collaboration.

Computing system 910 may be implemented as a single apparatus, system, or device or may be implemented in a distributed manner as multiple apparatuses, systems, or devices. Computing system 910 includes, but is not limited to, processing system 920, storage system 930, software 940, communication interface system 950, and user interface system 960. Processing system 920 is operatively coupled with storage system 930, communication interface system 950, and an optional user interface system 960.

Processing system 920 loads and executes software 940 from storage system 930. When executed by processing system 920 for deployment of scope-based certificates in multi-tenant cloud-based content and collaboration environments, software 940 directs processing system 920 to operate as described herein for at least the various processes, operational scenarios, and sequences discussed in the foregoing implementations. Computing system 910 may optionally include additional devices, features, or functionality not discussed for purposes of brevity.

Referring still to FIG. 9, processing system 920 may comprise a micro-processor and other circuitry that retrieves and executes software 940 from storage system 930. Processing system 920 may be implemented within a single processing device, but may also be distributed across multiple processing devices or sub-systems that cooperate in executing program instructions. Examples of processing system 920 include general purpose central processing units, application specific processors, and logic devices, as well as any other type of processing device, combinations, or variations thereof.

Storage system 930 may comprise any computer readable storage media readable by processing system 920 and capable of storing software 940. Storage system 930 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 930 may also include computer readable communication media over which at least some of software 940 may be communicated internally or externally. Storage system 930 may be implemented as a single storage device, but may also be implemented across multiple storage devices or sub-systems co-located or distributed relative to each other. Storage system 930 may comprise additional elements, such as a controller, capable of communicating with processing system 920 or possibly other systems.

Software 940 may be implemented in program instructions and among other functions may, when executed by processing system 920, direct processing system 920 to operate as described with respect to the various operational scenarios, sequences, and processes illustrated herein. For example, software 940 may include program instructions for directing the system to perform the processes described above.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 940 may include additional processes, programs, or components, such as operating system software, virtual machine software, or application software. Software 940 may also comprise firmware or some other form of machine-readable processing instructions executable by processing system 920.

In general, software 940 may, when loaded into processing system 920 and executed, transform a suitable apparatus, system, or device (of which computing system 910 is representative) overall from a general-purpose computing system into a special-purpose computing system. Indeed, encoding software on storage system 930 may transform the physical structure of storage system 930. The specific transformation of the physical structure may depend on various factors in different implementations of this description. Examples of such factors may include, but are not limited to, the technology used to implement the storage media of storage system 930 and whether the computer-storage media are characterized as primary or secondary storage, as well as other factors.

For example, if the computer readable storage media are implemented as semiconductor-based memory, software 940 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 950 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 960 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 960. In some cases, the input and output devices may be combined in a single device, such as a display capable of displaying images and receiving touch gestures. The aforementioned user input and output devices are well known in the art and need not be discussed at length here. In some cases, the user interface system 960 may be omitted when the computing system 910 is implemented as one or more server computers such as, for example, blade servers, rack servers, or any other type of computing server system (or collection thereof).

User interface system 960 may also include associated user interface software executable by processing system 920 in support of the various user input and output devices discussed above. Separately or in conjunction with each other and other hardware and software elements, the user interface software and user interface devices may support a graphical user interface, a natural user interface, or any other type of user interface, in which a user interface to a productivity application may be presented.

Communication between computing system 910 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. In any of the aforementioned examples in which data, content, or any other type of information is exchanged, the exchange of information may occur in accordance with any of a variety of well-known data transfer protocols.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for operating a space optimization tool to determine office space locations of members within an organization, the method comprising:
identifying interactions between members of multiple teams within the organization;
determining, based on the interactions between the members of the multiple teams within the organization, an interaction matrix that represents a number of interactions between each of the multiple teams;
creating a travel matrix based on travel times between the multiple teams during the interactions of the members of the multiple teams; and
generating a smart location plan identifying how the multiple teams should be physically located within the organization,
wherein the smart location plan is generated, at least in part, by solving an optimization problem that minimizes an objective function based on the interaction matrix and the travel matrix subject to one or more constraints.

2. The method of claim 1, wherein identifying interactions between the members of the multiple teams within the organization includes:
accessing e-mail and calendar data from each member of the multiple teams;
identifying, based on the e-mail and calendar data, meetings between the members of the multiple teams; and
recording locations of the meetings between the members of the multiple teams.

3. The method of claim 1, wherein the space optimization tool uses a Frank-Wolfe algorithm to solve the optimization problem.

4. The method of claim 1, further comprising generating graphical user interface that can be displayed on a client device, wherein the graphical user interface includes:
a first interface that allows a user of the client device to enter capacity of one or more locations on which the members within the organization can be located; and
wherein the optimization problem uses the capacity of the one or more locations as a constraint in generating the smart location plan.

5. The method of claim 4, wherein the graphical user interface includes a graphical display representing the smart location plan as a table of team members per location.

6. The method of claim 5, wherein optimization problem uses a constraint to ensure that every member of each team is placed in the one or more locations.

7. The method of claim 1, wherein the optimization tool solves the optimization problem multiple times from different initial conditions, records a corresponding value for the objective function, and sets a solution of the optimization problem with a lowest value as the smart location plan.

8. A space optimization system comprising:
a memory;
one or more processors;
an interaction module, under control of the one or more processors, to:
identify interactions between members of multiple teams within an organization;
determine, based on the interactions between the members of the multiple teams within the organization, an interaction matrix that represents a number of interactions between each of the multiple teams;
a travel module, under control of the one or more processors, to create a travel matrix based on travel times between the multiple teams during the interactions of the members of the multiple teams; and
an optimization module, under control of the one or more processors, to generate a smart location plan identifying how the multiple teams should be physically located within the organization,
wherein the smart location plan is generated, at least in part, by solving an optimization problem that minimizes an objective function based on the interaction matrix and the travel matrix subject to one or more constraints.

9. The space optimization system of claim 8, further comprising:
a database having stored thereon e-mail and calendar data from members of the multiple teams; and
an identification module, under the control of the one or more processors, to:
identify, based on the e-mail and calendar data, meetings between the members of the multiple teams; and
record a location of the meetings between the members of the multiple teams.

10. The space optimization system of claim 8, wherein the optimization module uses a Frank-Wolfe algorithm to solve the optimization problem.

11. The space optimization system of claim 8, further comprising a graphical user interface generation module configured to generate a generating graphical user interface that can be displayed on a client device, wherein the graphical user interface includes:
a first interface that allows a user of the client device to enter capacity of one or more locations on which the members within the organization can be located;
a second interface that allows a user of the client device to set placement of a certain number of members on specific locations; and
a constraint module that receives the capacity of the one or more locations and the set placement of the certain number of members on specific locations and generates one or more constraints that are used in generating the smart location plan.

12. The space optimization system of claim 8, wherein the graphical user interface includes a graphical display representing the smart location plan as a table of team members per location.

13. The space optimization system of claim 8, wherein smart location plan is generated using an additional constraint to ensure that every member of each team is placed in one or more locations.

14. The space optimization system of claim 8, wherein the optimization module finds a descent direction and uses a line search to minimize the objective function.

15. A method of generating a smart location plan, performed by a machine, the method comprising:
receiving a set of interaction data identifying interactions between members of multiple teams within an organization;
determining, based on the interactions between the members of the multiple teams within the organization, an interaction matrix that represents the interactions between each of the multiple teams,
wherein each entry in the interaction matrix represents collaboration intensity between individual teams;
creating a travel matrix based on travel times between the multiple teams during the interactions of the members of the multiple teams,
wherein each entry in the travel matrix represents an amount of time needed to travel from one location to another; and
selecting an initial allocation of team members on each location and proceeding to generate a potential smart location plan in an iterative manner based on the initial allocation of team members by solving an optimization problem that minimizes an objective function based on the interaction matrix and the travel matrix subject to one or more constraints,
wherein a gradient of the objective function is calculated based on the initial allocation and a step size is selected that is used to iteratively select a new allocation until a distance between successive iterations is less than a set value;
wherein a set number of additional allocations are selected and used to determine additional potential smart location plans; and
selecting a final smart location plan from the potential smart location plans based on the lowest value of the objective function,
wherein the final smart location plan identifies how the multiple teams should be physically located within the organization.

16. The method of claim 15, further comprising identifying the interactions between the members of the multiple teams within the organization by:
accessing e-mail and calendar data from each member of the multiple teams;
identifying, based on the e-mail and calendar data, meetings between the members of the multiple teams; and
recording the location of the meetings between the members of the multiple teams.

17. The method of claim 15, further comprising generating a graphical user interface that can be displayed on a client device, wherein the graphical user interface includes:
a first interface that allows a user of the client device to enter a capacity of one or more locations on which the members within the organization can be located;
wherein the optimization problem uses the capacity of the one or more locations as a constraint in generating the smart location plan; and
a second interface that graphical displays the final smart location plan as a table of team members per location.

18. The method of claim 17, further comprising:
receiving a modification via the second interface of the final smart location plan; and
generating an updated final smart location plan based on the modification received via the second interface.

19. The method of claim 15, further comprising updating the step size on each interaction.

20. The method of claim 15, further comprising accessing a human relations database that to gather human relation meta data regarding a level, job function, and current physical location of each of the members of the multiple teams.
